(19) United States
(12) Patent Application Publication
(10) Pub. No.: US 2026/0273789 A1
(43) Pub. Date: Sep. 17, 2026

(54) PUNCHING MACHINE WITH REPLACEABLE PUNCHING CORE

(71) Applicant: DONGGUAN JIAXI OFFICE MACHINE CO.,LTD., Dongguan (CN)

(72) Inventor: Haocai ZHENG, Dongguan (CN)

(21) Appl. No.: 19/678,038

(22) Filed: May 14, 2026

Related U.S. Application Data
(63) Continuation-in-part of application No. 19/369,226, filed on Oct. 26, 2025.

(30) Foreign Application Priority Data
Aug. 14, 2025 (CN) 202521736711.5

(51) Int. Cl. B26F 1/14

(52) U.S. Cl. CPC B26F 1/14

(57) ABSTRACT

A punching machine with a replaceable punching core, including a mounting base, a replaceable punching core, a control handle. The mounting base is configured to carry a sheet material to be punched. The replaceable punching core is detachably mounted on the mounting base, and the replaceable punching core comprises a punching assembly. The control handle is rotatably connected to the mounting base and configured to drive the punching assembly of the replaceable punching core downward, thereby performing a punching operation on the sheet material carried on the mounting base.

### CROSS-REFERENCE TO RELATED APPLICATIONS

This application is a continuation in part application of application number 19/369,226, filed October 26, 2025, which claims priority to Chinese patent application 202521736711.5, filed on August 14, 2025. The contents of these applications are incorporated herein by reference in their entirety.

### TECHNICAL FIELD

The present disclosure relates to the technical field of office punching equipment, in particular to a punching machine with a replaceable punching core.

### BACKGROUND

With the advancement of office automation and the increasing demand for personalization, the need for efficient and flexible punching and binding of sheet materials such as documents, bills, leather, and handicrafts has been growing day by day. While consumers pursue operational convenience and functional diversification, they have imposed higher requirements on the maintenance convenience of the equipment, the labor-saving nature of operation, and the compactness of the overall structure.

At present, punching equipment available on the market generally suffers from the following notable problems: the punching core cannot be replaced, or the replacement operation is complicated, resulting in high maintenance costs. Mainstream punching machines typically employ fixed-type knife heads or structurally complex replaceable knife designs. When the knife head becomes worn or it is necessary to switch to punching specifications with different hole diameters or shapes, the process often requires the use of tools for cumbersome disassembly and assembly. In some cases, multiple components must be disassembled or precision alignment mechanisms must be adjusted. This not only renders the operation time-consuming and labor-intensive, but also tends to accelerate wear on the connecting structures, thereby affecting the precision and service life of the punching equipment. In addition, existing punching equipment has a single function, with punching and binding generally required to be performed in separate steps. Even in the few punching machines that integrate a binding function, the binding structure is difficult to adapt to binding iron rings of different sizes. When users face requirements for multiple binding sizes, they still need to frequently adjust or replace the equipment. The equipment is bulky, the operation is cumbersome, and it is difficult to meet the demands of efficient work.

### SUMMARY

In order to overcome the deficiencies of the prior art, the present disclosure provides a punching machine with a replaceable punching core that has a simple structure, enables convenient and portable replacement of the punching core, and whose binding structure is also capable of adapting to binding iron rings of different sizes.

To realize the above objective, the present disclosure provides a punching machine with a replaceable punching core, including: a mounting base configured to carry a sheet material to be punched; a replaceable punching core, which is detachably mounted on the mounting base, and the replaceable punching core comprises a punching assembly; a control handle, which is rotatably connected to the mounting base and configured to drive the punching assembly of the replaceable punching core downward, thereby performing a punching operation on the sheet material carried on the mounting base.

Preferably, the punching machine with the replaceable punching core further comprises an iron ring pressing assembly, the iron ring pressing assembly comprises a pressing fixed plate and a pressing movable plate; when the control handle is rotated downward, the pressing movable plate moves toward the pressing fixed plate to press a binding iron ring located between the pressing fixed plate and the pressing movable plate; an initial position of the pressing fixed plate is adjustable to accommodate binding iron rings of different sizes.

Preferably, the iron ring pressing assembly further comprises an adjusting control component and an adjusting execution component; the adjusting execution component is fixedly connected to the pressing fixed plate, the adjusting control component is slidably connected to the adjusting execution component; and the initial position of the pressing fixed plate is adjusted to move closer to or away from the pressing movable plate by operating the adjusting execution component.

Preferably, the adjusting execution component is provided with a sliding groove, the adjusting control component is provided with a sliding rod; the sliding rod is slidably received in the sliding groove, and the position of the adjusting execution component is adjusted by adjusting a position of the sliding rod relative to the sliding groove, thereby moving the initial position of the pressing fixed plate to move closer to or away from the pressing movable plate.

Preferably, the adjusting control component is provided with a control portion, the mounting base further comprises a through slot, and the control portion extends out of and is slidably connected to the through slot.

Preferably, the mounting base is provided with a handle installing shaft, the control handle is provided with a handle installing hole that cooperates with the handle installing shaft; the mounting base and the control handle are rotatably connected through the handle installing shaft.

Preferably, the punching machine with the replaceable punching core further comprises an elastic reset assembly sleeved on the handle installing shaft; and the elastic reset assembly is configured to drive the control handle to automatically return to an initial position after the punching operation is completed.

Preferably, the elastic reset assembly comprises an elastic component and an abutting rod; the abutting rod is fixedly connected to the mounting base, and the elastic component is sleeved on the handle installing shaft and configured to abut against the abutting rod.

Preferably, the punching machine with the replaceable punching core further comprises a driving gear and a transmission assembly; the driving gear is fixedly sleeved on the handle installing shaft and provided with a first gear portion, the transmission assembly is vertically and slidably connected to the mounting base; and the transmission assembly is provided with a transmission engaging hole that meshes with the first gear portion.

Preferably, when the control handle is rotated downward, the driving gear rotates accordingly and drives the transmission assembly to move downward through a mesh engagement between the first gear portion and the transmission engaging hole.

Preferably, the transmission assembly further comprises an executing plate, the executing plate is provided with an executing slot; the punching assembly comprises a punching pressure plate and a punching blade; the executing slot clamps the punching pressure plate, and the punching pressure plate abuts against the punching blade; when the transmission assembly moves downward, the executing plate is driven to move downward, and then the punching blade is driven to move downward through the punching pressure plate clamped in the executing slot, so as to punch the sheet material carried on the mounting base.

Preferably, the punching machine with the replaceable punching core further comprises a limiting assembly, the limiting assembly is configured to lock the control handle at the lowest position of a swing stroke.

Preferably, the limiting assembly comprises a limiting plate and a control card; the limiting plate is fixedly connected to the executing plate so as to move together with the movement of the executing plate; and the limiting plate is provided with a locking portion.

Preferably, the control card is slidably connected to the mounting base and is provided with a control abutment portion; when the control handle reaches the lowest position of the swing stroke, the control abutment portion abuts against the locking portion.

Preferably, when the control abutment portion abuts against the locking portion, the limiting assembly locks the control handle against an elastic force of the elastic reset assembly.

Preferably, the punching machine with the replaceable punching core further comprises a base positioning assembly, the base positioning assembly is disposed on the mounting base and configured to transversely adjust a position of the sheet material to be punched.

Preferably, the mounting base is provided with a mounting sink slot, and an outer contour of the bottom of the replaceable punching core matches the mounting sink slot.

Preferably, the iron ring pressing assembly further comprises a joining component, the joining component is fixedly connected to the pressing movable plate.

Preferably, the joining component is provided with a pressing engaging hole, the driving gear is further provided with a second gear portion; when the control handle is rotated downward, the driving gear drives the joining component through a mesh engagement between the second gear portion and the pressing engaging hole, thereby driving the pressing movable plate move toward the pressing fixed plate to press the binding iron ring located between the pressing fixed plate and the pressing movable plate.

Preferably, the mounting base further comprises an iron ring installing portion; the iron ring installing portion is disposed correspondingly to the iron ring pressing assembly and configured to assist in mounting the binding iron ring onto the sheet material on which the punching operation has been completed, before the iron ring pressing assembly presses the binding iron ring.

The beneficial effects of the present disclosure are: during use, the detachable installation design of the replaceable punching core enables the punching machine to flexibly adapt to the punching requirements of various sheet materials (such as paper, leather, plastic sheets, and the like) by replacing the replaceable punching cores of different sizes, which not only reduces the punching machine purchase cost but also simplifies the later maintenance process—when the replaceable punching core is worn or damaged, it is only necessary to separately replace the replaceable punching core, without the need to disassemble the main body of the punching machine, thereby effectively improving the versatility and service life of the punching machine. The integrated design of the iron ring pressing assembly combines the punching and binding functions into one, avoiding the cost and space occupation of the user separately purchasing two punching machines. What is particularly critical is that the initial position adjustable structure of the pressing fixed plate enables the punching machine to adapt to binding iron rings of different sizes through simple operations, allowing the user to quickly switch between multiple binding sizes without the aid of tools or replacement of accessories, thereby significantly enhancing the flexibility and efficiency of binding operations.

### BRIEF DESCRIPTION OF DRAWINGS

In order to more clearly illustrate the technical solutions in the embodiments of the present disclosure, the drawings required for use in the description of the embodiments will be briefly introduced below. The drawings in the following description are merely some embodiments of the present disclosure. For those of ordinary skill in the art, other drawings can also be obtained based on these drawings without creative effort. In addition, the drawings are not drawn to a 1:1 scale, and the relative sizes of the various components in the drawings are merely illustratively drawn and are not necessarily drawn according to actual proportions.

The present disclosure will be further described below in conjunction with the drawings and embodiments.

FIG. 1 is a schematic structural diagram of a punching machine with a replaceable punching core according to an embodiment of the present disclosure, viewed from a first angle, with a control handle in the initial position.

FIG. 2 is a schematic structural diagram of the punching machine with the replaceable punching core, viewed from a second angle, with the control handle in the initial position.

FIG. 3 is a schematic structural diagram of a part of the punching machine with the replaceable punching core, with the control handle located at the lowest position of its swing stroke.

FIG. 4 is an enlarged view of an area A in FIG. 3.

FIG. 5 is an exploded view of the punching machine with the replaceable punching core.

FIG. 6 is an exploded view of a replaceable punching core of the punching machine with the replaceable punching core.

FIG. 7 is a schematic structural diagram of the punching machine with the replaceable punching core, in which a pressing fixed plate is in an initial position and is configured to assist in installing the binding iron ring on the punched sheet material.

FIG. 8 is a schematic structural diagram of the punching machine with the replaceable punching core, in which the pressing fixed plate is in the initial position and is configured to press an iron ring.

FIG. 9 is another schematic structural diagram of the punching machine with the replaceable punching core, in which the pressing fixed plate is in the initial position and is configured to press the iron ring.

FIG. 10 is a schematic structural diagram of a pressing fixed plate of the punching machine with the replaceable punching core, in which the pressing fixed plate is in another initial position and is configured to press the iron ring.

### Description of the reference numerals:

1. sheet material; 2. binding iron ring; 100. mounting base; 200. replaceable punching core; 300. control handle; 400. iron ring pressing assembly; 500. elastic reset assembly; 600. driving gear; 700. transmission assembly; 800. limiting assembly; 900. base positioning assembly; 110. through slot; 120. handle installing shaft; 130. mounting sink slot; 140. iron ring installing portion; 210. punching assembly; 211. punching pressure plate; 212. punching blade; 310. handle installing hole; 410. pressing fixed plate; 420. pressing movable plate; 430. adjusting control component; 431. sliding rod; 432. control portion; 440. adjustment execution component; 441. sliding groove; 450. joining component; 451. pressing engagement hole, 510. elastic component; 520. abutting rod; 610. first gear portion; 620. second gear portion; 710. transmission engagement hole; 720. executing plate; 721. executing slot; 810. limiting plate; 811. locking portion; 820. control card; 821. control abutment portion.

### DETAILED DESCRIPTION OF THE EMBODIMENTS

In order to make the above-mentioned purposes, features and advantages of the present disclosure more obvious and easier to understand, the specific implementation modes of the present disclosure are described in detail below in conjunction with the accompanying drawings. In the following description, many specific details are set forth in order to facilitate a full understanding of the present disclosure. However, the present disclosure can be implemented in many other ways different from those described herein, and those skilled in the art can make similar improvements without departing from the connotation of the present disclosure. Therefore, the present disclosure is not limited by the specific embodiments disclosed below.

In the description of the present disclosure, it should be understood that if the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc. appear, these terms indicate the orientation or positional relationship based on the orientation or positional relationship shown in the drawings, and are only for the convenience of describing the present disclosure and simplifying the description, rather than indicating or implying that the device or element referred to must have a specific orientation, be constructed and operated in a specific orientation, and therefore cannot be understood as a limitation on the present disclosure.

In addition, if the terms “first” and “second” appear, these terms are used for descriptive purposes only and cannot be understood as indicating or implying relative importance or implicitly indicating the number of technical features indicated. Thus, a feature defined as “first” or “second” may explicitly or implicitly include at least one of the features. In the description of the present disclosure, if the term “plurality” or “multiple” appears, the meaning of “plurality” or “multiple” is at least two, for example two, three, etc., unless otherwise clearly and specifically limited.

In the present disclosure, unless otherwise clearly specified and limited, if the terms “install”, “connect”, “link”, “fix”, etc. appear, these terms should be understood in a broad sense. For example, it may be a fixed connection, a detachable connection, or an integral connection; it may be a mechanical connection or an electrical connection; it may be a direct connection or an indirect connection through an intermediate medium, and it may be the internal communication of two elements or the interaction relationship between two elements, unless otherwise clearly limited. For those of ordinary skill in the art, the specific meanings of the above terms in the present disclosure can be understood according to specific circumstances.

In the present disclosure, unless otherwise clearly specified and limited, if there is a description such as the first feature being “on” or “under” the second feature, its meaning may be that the first and second features are in direct contact, or that the first and second features are in indirect contact through an intermediate medium. Moreover, the first feature being “above”, “over” and “on” the second feature may mean that the first feature is directly above or obliquely above the second feature, or merely indicates that the first feature is horizontally higher than the second feature. The first feature being “below”, “under” and “beneath” the second feature may mean that the first feature is directly below or obliquely below the second feature, or merely indicates that the first feature is horizontally lower than the second feature.

It should be noted that if an element is referred to as being “fixed to” or “disposed on” another element, it may be directly on the other element or there may also be a centered element. If an element is considered to be “connected to” another element, it may be directly connected to the other element or there may simultaneously be a centered element. If present, the terms “vertical”, “horizontal”, “upper”, “lower”, “left”, “right” and similar expressions used in the present disclosure are for illustrative purposes only and do not represent the only implementation manner.

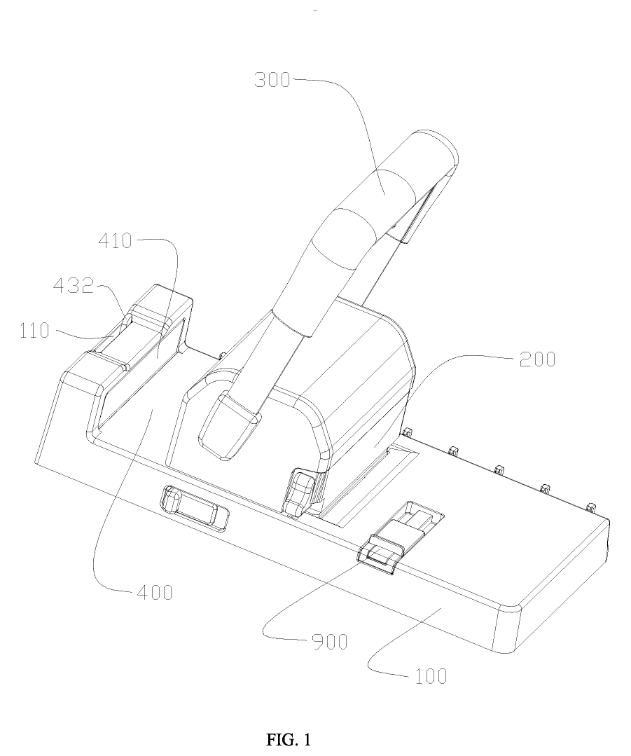

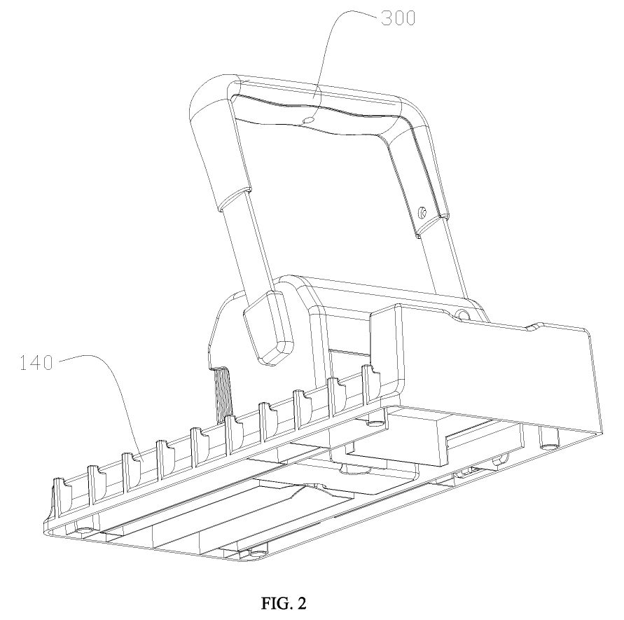

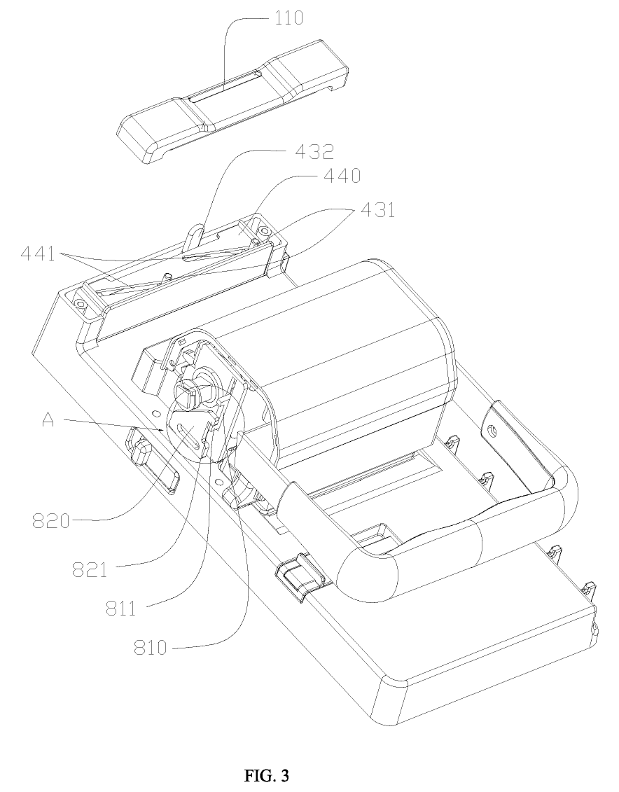

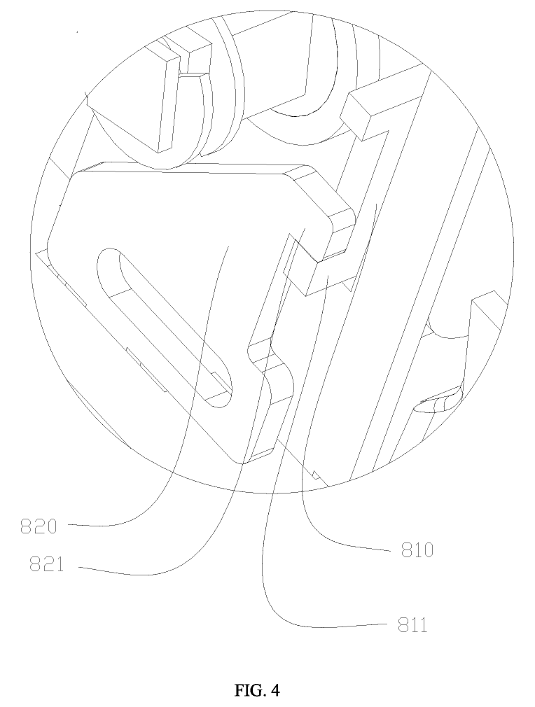

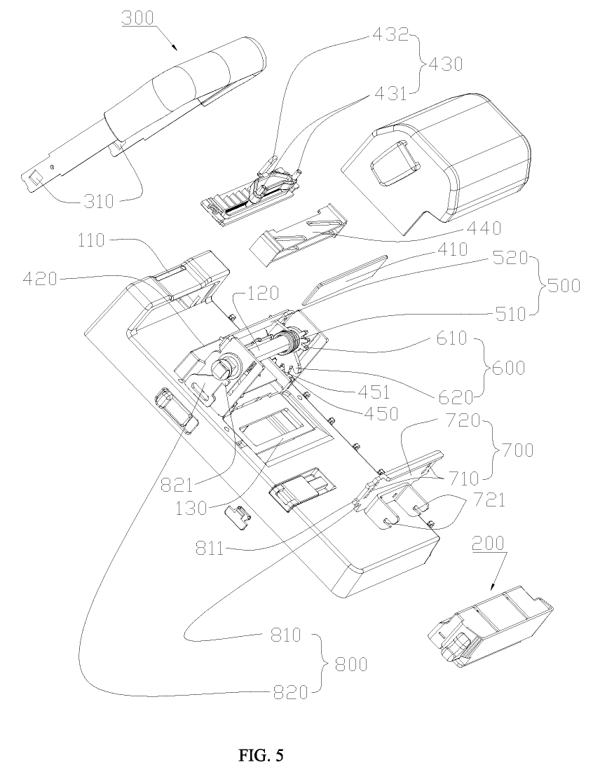

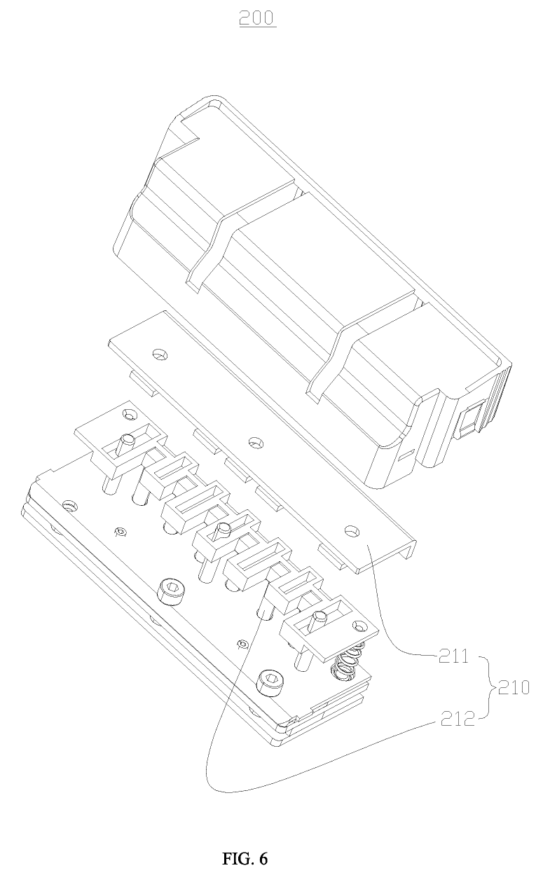

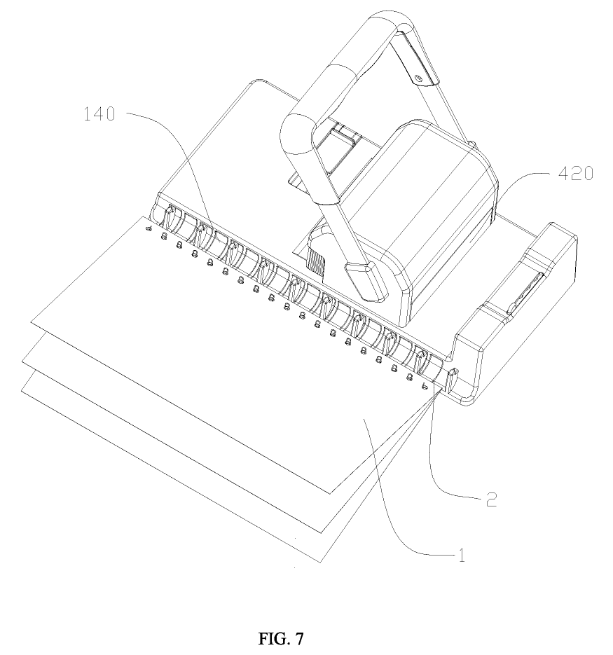

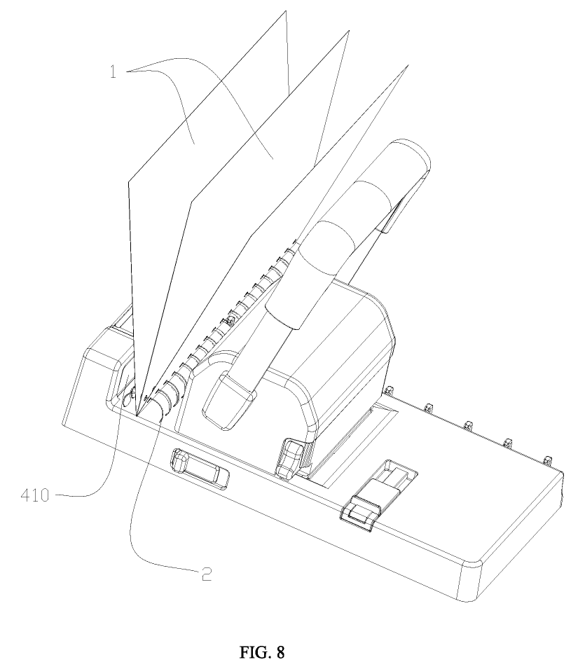

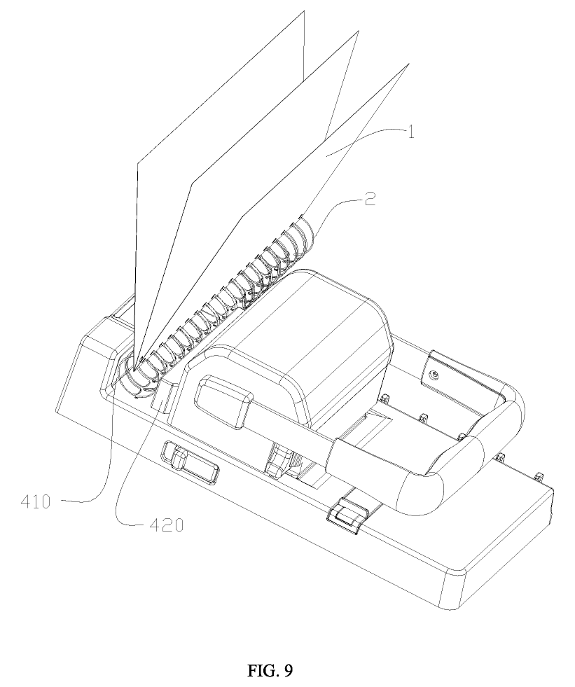

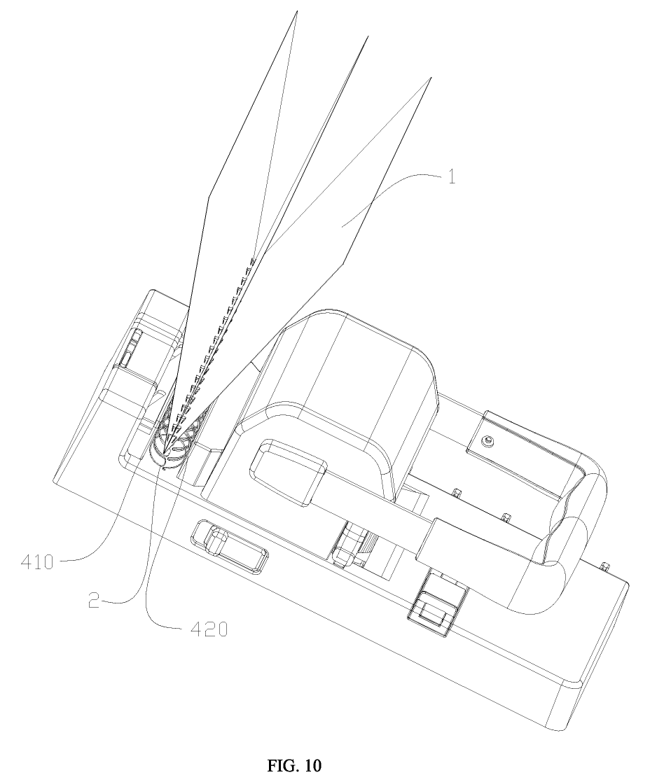

Referring to FIGS. 1 to 10, a punching machine with a replaceable punching core according to an embodiment of the present disclosure includes: a mounting base 100, a replaceable punching core 200, and a control handle 300.

The mounting base 100 is configured to carry a sheet material to be punched. The replaceable punching core 200 is detachably mounted on the mounting base 100, and the replaceable punching core 200 includes a punching assembly 210. The control handle 300 is rotatably connected to the mounting base 100, and configured to drive the punching assembly 210 of the replaceable punching core 200 downward, thereby performing a punching operation on the sheet material 1 carried on the mounting base.

Through the arrangement of the foregoing structure, in use, the mounting base 100 serves as a basic carrying structure that provides a stable placement platform for the sheet material 1 to be punched, thereby ensuring that the position of the sheet material 1 remains fixed during the punching process and constituting the reference datum for operation of the entire apparatus. The replaceable punching core 200 is connected to the mounting base 100 in a detachable manner, and the punching assembly 210 contained therein constitutes the core component for performing the punching operation, such detachable design enabling the apparatus to rapidly replace an adapted replaceable punching core 200 according to different punching requirements, thereby greatly improving the universality and operational flexibility of the apparatus. The control handle 300 is combined with the mounting base 100 through a rotatable connection. An operator may drive the punching assembly 210 to move downward by rotating the control handle 300, realizing stamping and punching of the sheet material through mechanical transmission, which not only simplifies the operation procedure but also ensures stable and controllable punching force through force transmission of the control handle 300. Overall, through functional division of labor and linkage among the respective components, convenient, precise, and flexibly adjustable punching operation on sheet material is realized.

In the present embodiment, the punching machine further includes an iron ring pressing assembly 400 having a pressing fixed plate 410 and a pressing movable plate 420. When the control handle 300 rotates downward, the pressing movable plate 420 moves toward the pressing fixed plate 410 and presses a binding iron ring 2 located between the pressing fixed plate 410 and the pressing movable plate 420. An initial position of the pressing fixed plate 410 is adjustable to accommodate binding iron rings 2 of different sizes. Through the addition of the iron ring pressing assembly 400, the punching and binding functions are integrated into a single unit, allowing a user to directly perform iron ring binding immediately after completing punching without switching equipment, thereby improving operation efficiency. The pressing fixed plate 410 and the pressing movable plate 420 cooperate to form a pressing working area. When the control handle 300 rotates downward, the pressing movable plate 420 moves toward the pressing fixed plate 410 to realize pressing and closing of the binding iron ring 2, and such linkage design enables the punching and pressing operations to share the same power source, thereby avoiding structural redundancy caused by additionally providing a driving mechanism. At the same time, the initial position of the pressing fixed plate 410 is adjustable, so that a user can rapidly adjust the initial spacing between the pressing fixed plate 410 and the pressing movable plate 420 according to binding requirements to adapt to binding iron rings 2 of different sizes without replacing the iron ring pressing assembly 400 or using additional tools, thereby greatly enhancing the compatibility of the apparatus with different binding specifications. Overall, through synergistic integration of the punching and pressing functions and flexible adjustability of the pressing spacing, one-stop efficient operation from punching to binding is realized.

In the present embodiment, the iron ring pressing assembly 400 further includes an adjusting control component 430 and an adjusting execution component 440. The adjusting execution component 440 is fixedly connected to the pressing fixed plate 410, the adjusting control component 430 is slidably connected to the adjusting execution component 440, and the initial position of the pressing fixed plate 410 is controlled to approach or move away from the pressing movable plate 420 by operating the adjusting execution component 440. The adjusting execution component 440 is provided with a sliding groove 441, the adjusting control component 430 is provided with a sliding rod 431, the sliding rod 431 is slidably connected to the sliding groove 441. The position of the adjusting execution component 440 is controlled by slidingly adjusting the position of the sliding rod 431 relative to the sliding groove 441, thereby controlling the initial position of the pressing fixed plate 410 to approach or move away from the pressing movable plate 420. The adjusting control component 430 is provided with a control portion 432, the mounting base 100 further includes a through slot 110. The control portion 432 extends out of and is slidably connected to the through slot 110. The mounting base 100 is provided with a handle installing shaft 120, the control handle 300 is provided with a handle installing hole 310 that cooperates with the handle installing shaft 120. The mounting base 100 and the control handle 300 are rotatably connected through the handle installing shaft 120.

Through the arrangement of the foregoing structure, in use, the adjusting execution component 440 is fixedly connected to the pressing fixed plate 410 and the adjusting control component 430 is slidably connected to the adjusting execution component 440, the two components cooperating to constitute a transmission chain for position adjustment of the pressing fixed plate 410, so that a user can precisely control the position of the adjusting execution component 440 by operating the adjusting control component 430 and thereby drive the pressing fixed plate 410 to approach or move away from the pressing movable plate 420, realizing stepless adjustment of the pressing spacing. The sliding groove 441 provided on the adjusting execution component 440 slidably cooperates with the sliding rod 431 provided on the adjusting control component 430. The sliding groove and sliding rod cooperating structure provides precise motion guidance and limiting for the adjustment process, ensuring that the pressing fixed plate 410 always maintains a stable translational trajectory during adjustment and preventing pressing deviation or uneven force application caused by adjustment offset, while the specific stroke design of the sliding groove can also define the adjustment range and prevent a user from mistakenly operating beyond the adapted specification. The control portion 432 provided on the adjusting control component 430 extends out of the through slot 110 of the mounting base 100 and is slidably connected thereto, such a structure externalizes the adjustment operation interface to the surface of the apparatus so that a user can perform adjustment directly without disassembling the apparatus, thereby greatly improving the convenience and visibility of adjustment. At the same time, cooperation of the through slot 110 with the control portion 432 further defines the adjustment stroke and forms double limiting protection together with the sliding groove 441, ensuring the safety and reliability of the adjustment operation. In addition, the mounting base 100 cooperates with the handle installing hole 310 of the control handle 300 through the handle installing shaft 120 to form a rotatable connection. Such shaft-hole cooperating structure provides a precise rotational fulcrum for the entire power transmission, ensuring stability and transmission precision during swinging of the handle and laying a structural foundation for efficient and reliable execution of the punching and pressing actions. Overall, through the refined design of the adjustment assembly and the optimization of the handle connection structure, the foregoing structure realizes convenient adjustability, precise controllability of the pressing spacing, and stable and reliable operation of the whole-machine transmission system, thereby further enhancing the adaptation capability of the apparatus to binding iron rings of different sizes and the operational experience.

In the present embodiment, the punching machine further includes an elastic reset assembly 500 sleeved on the handle installing shaft 120. The elastic reset assembly 500 is configured to drive the control handle 300 to automatically return to the initial position after punching is completed, the elastic reset assembly 500 including an elastic component 510 and an abutting rod 520. The abutting rod 520 is fixedly connected to the mounting base 100, and the elastic component 510 is sleeved on the handle installing shaft 120 and abuts against the abutting rod 520. Through the arrangement of the foregoing structure, the introduction of the elastic reset assembly 500 adds an automatic return function to the apparatus, further improving operational convenience and user experience. Specifically, the elastic reset assembly 500 is sleeved on the handle installing shaft 120, fully utilizing the structural foundation of the handle installing shaft 120 as a rotational fulcrum to realize compact integration of the elastic reset assembly 500 with the transmission mechanism without additionally occupying internal space of the apparatus.

The elastic reset assembly 500 includes the elastic component 510 and the abutting rod 520. The abutting rod 520 is fixedly connected to the mounting base 100 to provide a stable abutment fulcrum for the elastic component 510. The elastic component 510 is sleeved on the handle installing shaft 120 and abuts against the abutting rod 520, so that when the control handle 300 rotates downward to perform punching or pressing operation, the elastic component 510 is compressed to store energy. After the punching operation is completed, the operator releases the control handle 300, the elastic component 510 releases the stored energy and drives the control handle 300 to automatically rotate in the reverse direction to return to the initial position. The automatic return design eliminates the need for the operator to manually pull the control handle 300 back, effectively simplifying the operation steps, and is particularly suitable for operation scenarios requiring multiple consecutive punching or frequent switching between punching and pressing functions, thereby significantly improving operation efficiency and operational fluency. At the same time, the coaxial sleeved layout of the elastic reset assembly 500 with the handle installing shaft 120 causes the return force to act directly on the rotational axis, thereby avoiding the influence of eccentric load moments on transmission precision and ensuring smoothness and reliability of the return process. Overall, through the integrated design of the elastic reset assembly 500 with the handle installing shaft 120, a cyclic operation mode of pressing operation and automatic return is realized, which not only reduces the labor intensity of the operator but also provides a structural foundation for subsequent locking and unlocking of a limiting assembly 800.

In the present embodiment, the punching machine further includes a driving gear 600 and a transmission assembly 700. The driving gear 600 is fixedly sleeved on the handle installing shaft 120 and is provided with a first gear portion 610, the transmission assembly 700 is vertically slidably connected to the mounting base 100. The transmission assembly 700 is provided with a transmission engagement hole 710 that meshes with the first gear portion 610. When the control handle 300 is rotated downward, the driving gear 600 rotates in synchronization therewith and, through meshing engagement between the first gear portion 610 and the transmission engagement hole 710, drives the transmission assembly 700 to move downward. The transmission assembly 700 is further provided with an executing plate 720 having an executing slot 721. The punching assembly 210 includes a punching pressure plate 211 and a punching blade 212. The executing slot 721 is snap-fitted to the punching pressure plate 211, and the punching pressure plate 211 abuts against the punching blade 212. When the transmission assembly 700 moves downward, it drives the executing plate 720 to move downward and, through the punching pressure plate 211 snap-fitted in the executing slot 721, further drives the punching blade 212 to move downward so as to punch the sheet material 1 carried on the mounting base 100. Through the arrangement of the foregoing structure, the cooperation of the driving gear 600 and the transmission assembly 700 constitutes a transmission linkage that converts the rotational motion of the control handle 300 into the linear motion of the punching assembly 210.

Specifically, the driving gear 600 is fixedly sleeved on the handle installing shaft 120. When the control handle 300 is rotated downward, the driving gear 600 rotates synchronously. The first gear portion 610 thereof meshes with the transmission engagement hole 710 provided on the transmission assembly 700. The mating configuration of the first gear portion 610 and the transmission engagement hole 710, as compared with a conventional gear-rack structure, provides a larger contact area and a more optimal force-distribution profile, thereby effectively withstanding the instantaneous impact load generated during the punching process and ensuring smooth and reliable transmission. The transmission assembly 700 is vertically slidably connected to the mounting base 100. Through the meshing engagement of the first gear portion 610 with the transmission engagement hole 710, the rotational motion of the driving gear 600 is precisely converted into the vertical linear motion of the transmission assembly 700. This transmission mode features a compact structure and a stable transmission ratio, so that the torque inputted by an operator through the control handle 300 can be transmitted to the punching assembly 210 at a constant ratio, thereby guaranteeing controllability and consistency of punching force.

The executing plate 720 provided on the transmission assembly 700 is snap-fitted to the punching pressure plate 211 through the executing slot 721, and the punching pressure plate 211 abuts against the punching blade 212. This snap-fit connection structure realizes rapid assembly and separation between the transmission assembly 700 and the replaceable punching core 200. When replacement of the punching core is required, disassembly is completed merely by disengaging the executing slot 721 from the punching pressure plate 211, without the need for any tool or disassembly of other transmission components, thereby greatly improving the efficiency and convenience of punching core replacement. When the transmission assembly 700 moves downward, it sequentially drives the executing plate 720, the punching pressure plate 211, and the punching blade 212 to move downward, ultimately performing the punching operation on the sheet material 1 carried on the mounting base 100. Through the meshing transmission between the driving gear 600 and the transmission engagement hole 710 as well as the rapid snap-fit cooperation between the executing plate 720 and the punching pressure plate 211, thereby realizing stability of power transmission, high efficiency of the transmission process, and convenience of punching core replacement, thereby providing a reliable guarantee for multi-specification adaptation and long-term stable operation of the apparatus.

In the present embodiment, the punching machine further includes a limiting assembly 800. The limiting assembly 800 is configured to lock the control handle 300 at the lowest position of its swing stroke. The limiting assembly 800 includes a limiting plate 810 and a control card 820, the limiting plate 810 is fixedly connected to the executing plate 720 so as to move in synchronization with the movement of the executing plate 720. The limiting plate 810 is provided with a locking portion 811, the control card 820 is slidably connected to the mounting base 100, and the control card 820 is provided with a control abutment portion 821. When the control handle 300 is locked at the lowest position of the swinging stroke, the control abutment portion 821 abuts against the locking portion 811, and when the control abutment portion 821 abuts against the locking portion 811, the limiting assembly 800 overcomes the elastic force of the elastic reset assembly 500 to lock the control handle 300. When the control abutment portion 821 abuts against the locking portion 811, the control abutment portion 821 is temporarily retained at the locking portion 811, such that the control handle 300 is locked at the lowest position of the swing stroke. When the control abutment portion 821 does not abut against the locking abutting portion 811, the control handle 300 automatically rebounds from the lowest position of the swing stroke Through the arrangement of the foregoing structure, the introduction of the limiting assembly 800 provides the apparatus with a transient holding function for the control handle 300, further enriching the flexibility of operation modes. Specifically, the limiting plate 810 is fixedly connected to the executing plate 720 and is therefore capable of moving synchronously with the executing plate 720. Such a connection manner directly correlates the positional state of the limiting plate 810 with the vertical position of the transmission assembly 700 without requiring any additional independent detection or linkage mechanism, resulting in a concise structure and a clear transmission path. The limiting plate 810 is provided with the locking portion 811, the control card 820 is slidably connected to the mounting base 100 and is provided with the control abutment portion 821. When the control handle 300 is rotated to the lowest position of the swinging stroke, a user can slide the control card 820 to cause the control abutment portion 821 to abut against the locking portion 811, thereby rapidly establishing or releasing the locked state. When the control abutment portion 821 abuts against the locking portion 811, the limiting assembly 800 overcomes the elastic force of the elastic reset assembly 500 and firmly locks the control handle 300 at the lowest position. In the locked state, the overall height of the punching machine is significantly reduced compared with the handle-reset state, enabling the apparatus to be packaged or stored in a minimum-volume configuration. On the one hand, this reduces the size of the packing box and lowers transportation and warehousing costs, and on the other hand, it facilitates storage by the user after use, which is particularly suitable for scenarios with limited desktop space or frequent relocation. When reuse is required, the user merely needs to slide the control card 820 in the reverse direction to release the lock, whereupon the elastic reset assembly 500 automatically drives the control handle 300 to reset to the initial position, restoring the apparatus to the ready-to-operate state. Overall, the limiting assembly 800, through its follower connection with the executing plate 720 and its synergistic cooperation with the elastic reset assembly 500, realizes a complete functional closed loop of operation-locking for storage-automatic reset, which not only satisfies multi-scenario operation requirements but also improves the portability and spatial adaptability of the product by optimizing the storage configuration of the whole machine.

In the present embodiment, the apparatus further includes a base positioning assembly 900 disposed on the mounting base 100, which is configured to transversely adjust the position of the sheet material 1 to be punched. Through the arrangement of the foregoing structure, the introduction of the base positioning assembly 900 further enhances the positioning accuracy and operational flexibility of the apparatus with respect to the sheet material 1, thereby providing the user with more refined operational control. The base positioning assembly 900, by the addition of the transverse adjustment function, forms a functional complement with the stable carrying function of the mounting base 100 and the specification adaptation of the replaceable punching core 200, upgrading the apparatus from coarse positioning to precise positioning and thereby furnishing the user with a more professional, efficient, and accurate punching experience.

In the present embodiment, the mounting base 100 is provided with a mounting sink slot 130, and the outer contour of the bottom of the replaceable punching core 200 matches the mounting sink slot 130. Through the arrangement of the foregoing structure, the matching design of the mounting sink slot 130 with the bottom outer contour of the replaceable punching core 200 provides an exact structural guarantee for rapid positioning and stable installation of the punching core. By virtue of the precise matching between the mounting sink slot 130 and the bottom outer contour of the replaceable punching core 200, rapid positioning, tool-free installation, and stable support of the replaceable punching core 200 are realized, which not only improves the efficiency and convenience of punching core replacement but also lays a structural foundation for long-term stable operation of the apparatus under multi-specification punching core switching.

In the present embodiment, the iron ring pressing assembly 400 further includes a joining component 450. The joining component 450 is fixedly connected to the pressing movable plate 420, the joining component 450 is provided with a pressing engagement hole 451, the driving gear 600 is further provided with a second gear portion 620. When the control handle 300 is rotated downward, the driving gear 600, through meshing engagement between the second gear portion 620 and the pressing engagement hole 451, drives the joining component 450 and, in turn, drives the pressing movable plate 420 to move toward the pressing fixed plate 410, thereby pressing and closing the binding iron ring 2 located between the pressing fixed plate 410 and the pressing movable plate 420. Through the arrangement of the foregoing structure, the addition of the joining component 450 establishes a direct transmission connection between the iron ring pressing assembly 400 and the driving gear 600, realizing a highly integrated design in which the punching and pressing functions share the same power source. Specifically, the joining component 450 is fixedly connected to the pressing movable plate 420 and is provided with the pressing engagement hole 451 thereon. In addition to the first gear portion 610 that meshes with the transmission assembly 700, the driving gear 600 is also provided with a second gear portion 620. When the control handle 300 is rotated downward, the driving gear 600 rotates synchronously, the second gear portion 620 meshes with the pressing engagement hole 451, and the joining component 450 is driven to further drive the pressing movable plate 420 to move toward the pressing fixed plate 410, thereby completing the pressing and closing of the binding iron ring 2. Such a structural design allows a single control handle 300 and a single driving gear 600 to simultaneously drive the punching assembly 210 to perform the punching action and the pressing movable plate 420 to perform the pressing action, truly realizing multi-function design driven by a single control handle and avoiding the structural complication and cost increase that would be caused by providing a separate drive mechanism for the pressing function. Meanwhile, the meshing engagement of the first gear portion 610 with the transmission engagement hole 710 and the meshing engagement of the second gear portion 620 with the pressing engagement hole 451 can be differentially designed according to actual functional requirements, for example, by setting different transmission ratios or initial meshing phases, so that the punching action and the pressing action are performed in a time-sharing or synchronous manner within the same rotational stroke of the control handle 300, thereby ensuring independent controllability of the two functions while optimizing the continuity of the operation flow. Overall, through the cooperation of the joining component 450 with the second gear portion 620 of the driving gear 600, the structure integrates the two core functions of punching and pressing into the same transmission linkage, which, while maintaining the compactness of the whole machine, significantly improves functional integration and operational efficiency and provides the user with a smoother one-stop operation experience.

In the present embodiment, the mounting base 100 further includes an iron ring installing portion 140 disposed in corresponding relationship with the iron ring pressing assembly 400, which is configured to assist in mounting the binding iron ring 2 onto the punched sheet material 1 prior to the pressing of the binding iron ring 2 by the iron ring pressing assembly 400.

By virtue of the arrangement of the foregoing structure, during use the addition of the iron ring installing portion 140 further perfects the full-process functional layout of the apparatus from hole punching through to binding, thereby furnishing the user with a more convenient and orderly binding operation experience.

More specifically, the iron ring installing portion 140, through its corresponding arrangement and functional cooperation with the iron ring pressing assembly 400, realizes a rational division of labor together with a smooth and seamless transition between the two steps of installing the binding iron ring and pressing within the binding operation; this configuration not only reduces the difficulty of the binding operation but also enhances the overall working efficiency as well as the consistency of finished-product quality.

The foregoing description sets forth one or more embodiments provided in conjunction with specific content and is not to be construed as limiting the specific implementations of the present disclosure solely to the foregoing descriptions. Any and all approximations, equivalents, or similarities to the method, structure, or other features of the present disclosure, or any technical deductions, substitutions, or improvements made on the premise of the inventive concept of the present disclosure, shall be deemed to fall within the protection scope of the present disclosure.

What is claimed is:

1. A punching machine with a replaceable punching core, comprising:
a mounting base configured to carry a sheet material to be punched;
a replaceable punching core, which is detachably mounted on the mounting base, and the replaceable punching core comprises a punching assembly;
a control handle, which is rotatably connected to the mounting base and configured to drive the punching assembly of the replaceable punching core downward, thereby performing a punching operation on the sheet material carried on the mounting base.

2. The punching machine with the replaceable punching core of claim 1, wherein the punching machine with the replaceable punching core further comprises an iron ring pressing assembly, the iron ring pressing assembly comprises a pressing fixed plate and a pressing movable plate;
wherein, when the control handle is rotated downward, the pressing movable plate moves toward the pressing fixed plate to press a binding iron ring located between the pressing fixed plate and the pressing movable plate;
wherein an initial position of the pressing fixed plate is adjustable to accommodate binding iron rings of different sizes.

3. The punching machine with the replaceable punching core of claim 2, wherein the iron ring pressing assembly further comprises an adjusting control component and an adjusting execution component;
wherein the adjusting execution component is fixedly connected to the pressing fixed plate, the adjusting control component is slidably connected to the adjusting execution component; and the initial position of the pressing fixed plate is adjusted to move closer to or away from the pressing movable plate by operating the adjusting execution component.

4. The punching machine with the replaceable punching core of claim 3, wherein the adjusting execution component is provided with a sliding groove, the adjusting control component is provided with a sliding rod;
wherein the sliding rod is slidably received in the sliding groove, and the position of the adjusting execution component is adjusted by adjusting a position of the sliding rod relative to the sliding groove, thereby moving the initial position of the pressing fixed plate to move closer to or away from the pressing movable plate.

5. The punching machine with the replaceable punching core of claim 4, wherein the adjusting control component is provided with a control portion, the mounting base further comprises a through slot, and the control portion extends out of and is slidably connected to the through slot.

6. The punching machine with the replaceable punching core of claim 2, wherein the mounting base is provided with a handle installing shaft, the control handle is provided with a handle installing hole that cooperates with the handle installing shaft; the mounting base and the control handle are rotatably connected through the handle installing shaft.

7. The punching machine with the replaceable punching core of claim 6, wherein the punching machine with the replaceable punching core further comprises an elastic reset assembly sleeved on the handle installing shaft; and the elastic reset assembly is configured to drive the control handle to automatically return to an initial position after the punching operation is completed.

8. The punching machine with the replaceable punching core of claim 7, wherein the elastic reset assembly comprises an elastic component and an abutting rod; the abutting rod is fixedly connected to the mounting base, and the elastic component is sleeved on the handle installing shaft and configured to abut against the abutting rod.

9. The punching machine with the replaceable punching core of claim 7, wherein the punching machine with the replaceable punching core further comprises a driving gear and a transmission assembly;
the driving gear is fixedly sleeved on the handle installing shaft and provided with a first gear portion, the transmission assembly is vertically and slidably connected to the mounting base; and the transmission assembly is provided with a transmission engaging hole that meshes with the first gear portion.

10. The punching machine with the replaceable punching core of claim 9, wherein, when the control handle is rotated downward, the driving gear rotates accordingly and drives the transmission assembly to move downward through a mesh engagement between the first gear portion and the transmission engaging hole.

11. The punching machine with the replaceable punching core of claim 10, wherein the transmission assembly further comprises an executing plate, the executing plate is provided with an executing slot; the punching assembly comprises a punching pressure plate and a punching blade;
wherein the executing slot clamps the punching pressure plate, and the punching pressure plate abuts against the punching blade;
when the transmission assembly moves downward, the executing plate is driven to move downward, and then the punching blade is driven to move downward through the punching pressure plate clamped in the executing slot, so as to punch the sheet material carried on the mounting base.

12. The punching machine with the replaceable punching core of claim 11, wherein the punching machine with the replaceable punching core further comprises a limiting assembly, the limiting assembly is configured to lock the control handle at the lowest position of a swing stroke.

13. The punching machine with the replaceable punching core of claim 12, wherein the limiting assembly comprises a limiting plate and a control card;
the limiting plate is fixedly connected to the executing plate so as to move together with the movement of the executing plate; and the limiting plate is provided with a locking portion.

14. The punching machine with the replaceable punching core of claim 13, wherein the control card is slidably connected to the mounting base and is provided with a control abutment portion;
wherein, when the control handle reaches the lowest position of the swing stroke, the control abutment portion abuts against the locking portion.

15. The punching machine with the replaceable punching core of claim 14, wherein, when the control abutment portion abuts against the locking portion, the limiting assembly locks the control handle against an elastic force of the elastic reset assembly.

16. The punching machine with the replaceable punching core of claim 1, wherein the punching machine with the replaceable punching core further comprises a base positioning assembly, the base positioning assembly is disposed on the mounting base and configured to transversely adjust a position of the sheet material to be punched.

17. The punching machine with the replaceable punching core of claim 1, wherein the mounting base is provided with a mounting sink slot, and an outer contour of the bottom of the replaceable punching core matches the mounting sink slot.

18. The punching machine with the replaceable punching core of claim 9, wherein the iron ring pressing assembly further comprises a joining component, the joining component is fixedly connected to the pressing movable plate.

19. The punching machine with the replaceable punching core of claim 18, wherein the joining component is provided with a pressing engaging hole, the driving gear is further provided with a second gear portion;
wherein, when the control handle is rotated downward, the driving gear drives the joining component through a mesh engagement between the second gear portion and the pressing engaging hole, thereby driving the pressing movable plate move toward the pressing fixed plate to press the binding iron ring located between the pressing fixed plate and the pressing movable plate.

20. The punching machine with the replaceable punching core of claim 2, wherein the mounting base further comprises an iron ring installing portion;
wherein the iron ring installing portion is disposed correspondingly to the iron ring pressing assembly and configured to assist in mounting the binding iron ring onto the sheet material on which the punching operation has been completed, before the iron ring pressing assembly presses the binding iron ring.
